(19) United States
(12) Patent Application Publication
(10) Pub. No.: US 2006/0158890 A1
(43) Pub. Date: Jul. 20, 2006

(54) Vehicle lighting system and isolation system therefor

(76) Inventor: Paul H. Freedman, Berkeley, CA (US)

Correspondence Address: Paul Freedman, 1336 Channing Way, Berkeley, CA, 94702, US

(21) Appl. No.: 10/863,314

(22) Filed: Jun. 7, 2004

(51) Int. Cl. B62J 6/00; F21V 33/00

(52) U.S. Cl. 362/390; 362/473

(57) ABSTRACT

A lightweight, shockproof lighting system designed to mount on the underside of a vehicle, providing decorative pattern of light on the ground beneath the vehicle, and providing significant visibility to others using the road. The lighting system is comprised of impact-resistant, waterproof transparent plastic tubes, which house fragile, elongated fluorescent lamps by cushioning them from road shock with springs. These light tubes also include an internal reflector, which directs more of the light towards the road. The lighting system is provided with a wiring arrangement for connection to a source of electrical power, such as a battery pack or wheel generator.

### BACKGROUND OF THE INVENTION

Cold Cathode Fluorescent Lamps (CCFL) are well known to those skilled in the art for their uses in display technologies and certain decorative applications. They are known for long life, high light output, low power consumption, low heat, and small form factor. However, due to their narrow diameter, they are vulnerable to breakage due to vibrations and extremely vulnerable to breakage from direct impacts.

Previous uses of linear CCFL lamps have typically supported the lamp by its end, spaced from a reflector, or affixed it to a reflective sleeve, which is then mounted to a rigid surface. These lamps are almost always designed so that the lamp itself is concealed from potentially intruding objects. Devices that use CCFL lamps are often expensive devices such as laptop computers that are not designed to sustain impacts.

When an acoustic guitar is dropped on the floor, the strings produce a chord, because the impact of the fall has been translated to the strings. In the case of an impact by a CCFL lamp, the weight of the lamp itself lags behind the motion of the object to which the lamp is attached. With a strong enough single impact, or with enough cycles of smaller, more regular vibrations, the lamp may break in the middle. This effect is seen at its strongest when the CCFL tube is supported at its ends and exposed to vibration.

Prior art has described many methods of protecting tubular light sources such as fluorescent lamps and neon lights, mostly by supplying a sleeve that protects the lamp from direct impacts. But the fluorescent lamp, by virtue of having a diameter that is an order larger than a CCFL lamp, and by virtue of having thicker glass walls than the CCFL lamp, is much more resistant to flex, A simple sleeve is not sufficient to protect a CCFL lamp against direct impacts and translated stresses.

Thus, current designs for protecting and housing tubular light sources such as fluorescent lamps are not readily applicable to CCFL lamps, and current methods for mounting CCFL lamps are not designed to sustain vibration. The limitations of the previous methods of housing and supporting tubular light sources has limited the types of applications for these types of lamps.

Having discussed the technical background of the invention, the context and need for the invention will now be discussed.

A well-known problem described in the prior art is that bicyclists, skateboarders, and joggers who use the streets after dark without lights are more vulnerable to being struck by other vehicles.

Considering the specific instance of bicycling after dark, this problem has largely been solved by numerous inventors and companies who have offered blinking LED-based safety lights, halogen headlights, and high intensity discharge headlights on par with motorcycle headlights in terms of brightness.

The majority of lighting devices for bicycles fall into two broad categories:
Lights that help cyclists see the road.
Lights that help cyclists be seen by car drivers and other cyclists.

The first category typically employs an incandescent, halogen, krypton, xenon, or similarly bright bulb, or a matrix of bright LED's in a headlight fixture, powered by a rechargeable battery. These types of lights provide sufficient brightness for cyclists to see the road or trail 20-60 feet ahead of the bicycle.

The second category of lighting devices are usually self-contained, lightweight, lowercost, LED-based flashing or steady lights, powered by AA or AAA primary batteries. Prior art describes tubular sources of light used to provide additional side-visibility to cars. However, in the prior art, there are no reflectors used to direct light from the lamp towards particular directions. As a result, much of the light escapes in unwanted directions:
In the eyes of the rider
Back towards the frame of the bicycle
Towards the sky

Examples in the prior art which use fluorescent lamps to provide side visibility detail a mounting system which relies on two straps or clamps holding the lamp at both ends. While this is an adequate and reliable way to hold a straight lamp to a straight bicycle tube, it does not work when the bicycle's frame has curves. Many cruisers and full-suspension bicycles do not have straight frame members.

The present invention uses a mounting system that is flexible enough for straight or curved frame styles.

Prior art does not include the use of cold cathode fluorescent lamps as a light source for bicycles.

The LED blinkers described above, which are ubiquitous in today's bicycle shops, have done a great service for cyclists, by providing a low-cost, effective safety light. A pair of front and rear LED-based blinkers costs less than a new pair of tires, and is more than adequate to keep a cyclist safe in most circumstances in urban riding.

Despite their effectiveness and low cost, there are several deficiencies of the standard safety lights.
1. Because they face forward and backward, the side visibility they provide is less effective than their front and rear visibility.
2. The lights are only effective when the power switch is in the ON position and when fresh batteries are installed.

While point 2 may seem obvious, it should be noted that many cyclists regularly forget or choose not to turn their lights on. Younger bicyclists, particularly teenagers, choose not to purchase the LED blinkers because:
they don't see a strong need to be highly visible to cars while riding after dark. (They either think an accident ‘will not happen to me’ or think they can avoid danger with nimble riding.)
they do not want to project the appearance of being safety conscious to their peers. For this reason many riders choose not to wear helmets.
the available lights are inconsistent with the style of their bicycles. (This is particularly true of so-called “Lowrider” bicycle enthusiasts who invest a lot of energy into the looks of their bicycles.)

Even if a parent buys a set of front and rear ‘LED blinkers’ for their child's bike, and their child does not like these lights, he or she may not turn the lights on, or may forget to change the batteries when they run out.

There is a need for bike lights that these younger, style-conscious riders will want to use, without prodding from parents, teachers, police officers, bike safety advocates, etc.

Bicycles have numerous benefits for the individuals who ride them and for their communities including: less local traffic, health benefits to the riders, less need to devote prime city real estate to parking, less street noise, lower cost of transportation, greater economic activity for local community businesses, less local pollution, and less contribution to global climate change.

However, the vast majority of able-bodied people only ride bicycles recreationally. Among the many reasons they do not choose to ride bicycles for transportation, for example, to and from work, or to and from social gatherings (concerts, bars, parties) at night, is that they do not feel safe riding amongst cars (especially at night), and because driving a car is more socially acceptable than riding a bicycle.

Given this broader challenge of communicating to drivers that bicycling is a viable and attractive alternative to driving, a safety product must do more than simply keep the rider safe. “Does it keep the rider safe?” is certainly the most important criteria, but another important question is, “Does this safety product make other road users more likely to try bicycling?”

References Cited:

| | | | |
|---|---|---|---|
| 3,124,307 | March 1964 | Hoskins | Vapor Lamp Units |
| 3,720,826 | March 1973 | Gilmore | Tubular Electric Discharge |
| | | | Lamp with Integral |
| | | | Protective Insulating |
| | | | Sleeve |
| 4,088,882 | May 1978 | Lewis | Fluorescent Bike Lamp |
| 4,337,503 | June 1982 | Turner | Handlebar Mounted |
| | | | Detachable Fixture |
| 4,819,135 | April 1989 | Padilla | Bicycle Lighting Device |
| 5,765,936 | June 1998 | Walton | Portable Neon Lighting |
| | | | System |
| 6,244,715 | June 2001 | McCauley | Mass Transit Vehicle |
| | | | Window Glare-Reducing |
| | | | Assembly |
| 6,422,721 | July 2002 | Plunk | Tube Guard System |
| 6,558,018 | May 2003 | Blum | Vehicle Light Apparatus |
| 6,616,310 | September 2003 | Marsh | CCFL Illuminated Device |

### SUMMARY

The present invention is a safety light for vehicles including a CCFL lamp mounted on springs that are housed in transparent thermoplastic tubing, so that it is isolated from both road vibration and direct impacts. Directional in nature, the invention includes a reflector so that it can direct the emitted light pattern, thereby reducing unwanted glare and maximizing the effect of the desired light pattern.

Returning to the context of bicycle safety, the present invention goes contrary to the prior art in that its light tube assemblies are designed to illuminate the road underneath the bicycle rather than shine in the eyes of approaching motorists. The light tube assemblies, when mounted on the underside of a bicycle, create a pleasant glow pattern on the road for up to 10 feet in all directions, depending on ambient light conditions. This pattern of light also serves an important safety function—it delineates a safety zone around the cyclist, causing drivers to yield more space to cyclists.

The present invention is slim, lightweight, extremely bright, and creates an effect that is similar to the decorative, neon under-carriage lights seen on lowrider cars. It can be produced in several colors, allowing the cyclist to choose their favorite color. For these reasons, it appeals to riders who would otherwise choose not to have a safety light on their bicycles.

The present invention addresses two of the main reasons why people choose not to ride bikes. It keeps cyclists highly visible to cars, from the front, side, and rear. And it provides a new, attractive, and distinctive way for cyclists to decorate their bicycles so that they feel comfortable making the choice to ride bicycles instead of drive cars. Thus the present invention helps more people choose to ride bicycles over cars to address some of their transportation needs.

### BRIEF DESCRIPTION OF THE DRAWINGS

FIG. 1 is a side view of the invention as mounted on a bicycle.

FIG. 2 is a side view of the light tube assembly. In the drawing, the light would be directed downward.

FIG. 3 is a straight on view of the light tube assembly. Here also the light, shown by arrows shines downward.

FIG. 4 is a top view of the bottom row of cells in the battery pack.

FIG. 5 is a top view of the top row of cells in the battery pack.

FIG. 6 is an oblique view of the battery pack.

### DESCRIPTION OF THE PREFERRED EMBODIMENT

With reference now to the drawings, and in particular FIG. 1 thereof, a new decorative safety lighting system embodying the principles and concepts of the present invention will be described.

The invention consists of one or two light tube assemblies 1 and 2, connected by wires to a power inverter 8, which draws power from a rechargeable or primary battery 10.

The front light tube assembly 1 mounts to the down tube 15 of a bicycle with a single plastic and rubber mount 3. Using a single mount as opposed to two mounts at each end of the light tube assembly allows the tube to be compatible with convexly curved bicycle frames, such as the popular cruiser design. The single mount 3 also allows the light tube assembly to move when hit, which adds to the protection of the CCFL lamp therein. Of course, bicycles with concavely curved down tubes will require two mounts at each end of the front light tube assembly. The front light tube assembly 1 is no wider than the down tube 15 of the bicycle. On most bicycles this means that the front light tube assembly is no greater than 1″ in diameter.

The front light tube creates visible light in a wide viewing angle. If the light tube assembly were positioned in the middle of a wide cylinder, the light would shine brightly on nearly 180 degrees of a circle, with the majority of the light focused on about 120 degrees of the circle. Thus, it is visible to the front and side of the bicycle.

The rear light tube assembly 2 mounts underneath the bicycle's left chainstay 16. The left chainstay is on the non-drive side of the bicycle, which means there is no interference between the light tube assembly and the chain of the bicycle. The rear light tube assembly 2 mounts to the left chainstay with hook-and-loop straps and H-shaped rubber brackets 4 and 5. This allows the user to accommodate a wide array of frame types and geometries. The rear light tube assembly is narrow enough as to mount beneath the chainstay of the bicycle without protruding towards the rear tire 17 or the left crank arm 18. On most bicycles this means that the rear light tube assembly 2 is no more than 1″ in diameter.

The light tube assemblies' power wires 6 and 7 run from one end of the light tube assemblies and pass between the left and right chainstays of the bicycle so as to be out of the pedal stroke and the chainring 14 of the bicycle. The light tube assemblies' power wires 6 and 7 connect to the power inverter 8, a lightweight box that is affixed to the frame of the bicycle by adhesive-backed hook-and-loop fastener.

The power inverter 8 connects to the battery 10 by way of a quick-disconnect power connecter 9.

The battery pack 10 contains an integrated power switch 11, which allows the user to turn the lights on and off without disconnecting and reconnecting the quick-disconnect power connecter 9. The battery pack mounts to the bicycle frame by means of an H-shape rubber bracket 12 and a hook-and-loop strap 13.

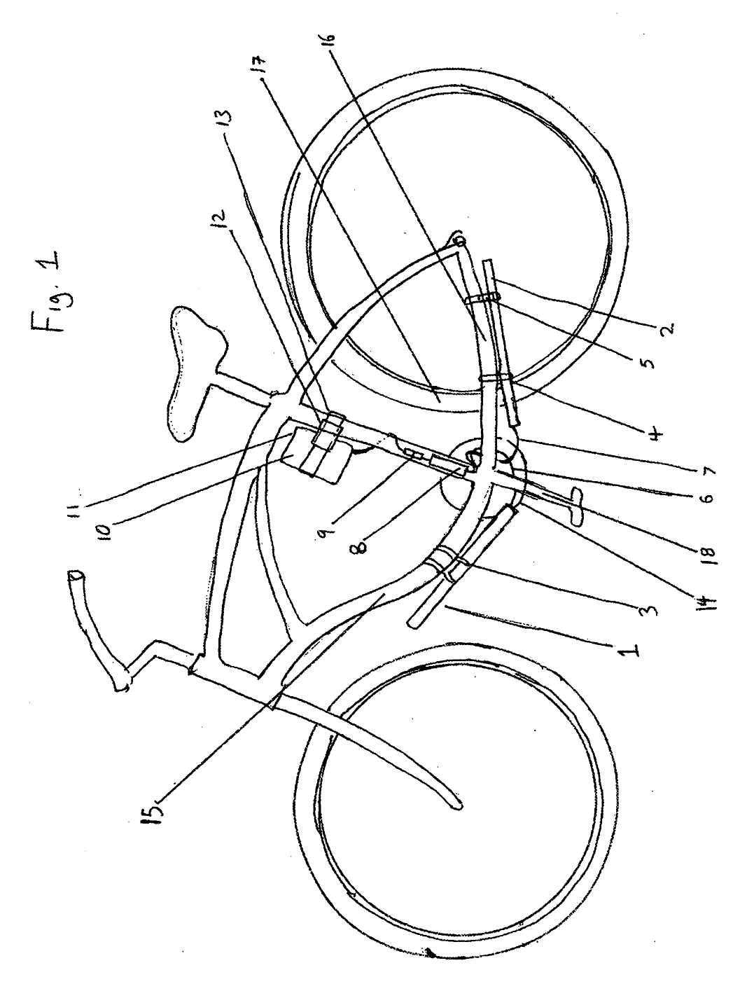

Referring now to FIG. 2, a close-up view of one of the light tube assemblies.

The light tube assembly 1 has as it structural element a tube 19 of lightweight, shock resistant transparent plastic such as polycarbonate. The ends of the polycarbonate tube 19 are sealed with plastic caps 20 and 29, one of which (29) has a hole drilled in it to allow the power wires of the CCFL lamp 23 to pass through. The light source, a Cold Cathode Florescent Lamp 23 is mounted in one or more springs 21a and 21b. In the preferred embodiment these springs are shock absorbing washers 21a and 21b of a very low durometer, made of white foam, transparent silicone rubber. The springs 21a and 21b are mounted away from the end of the light tube assembly that contains the power wire 27. Referring to the midpoint of the housing 50, average placement of the springs is closer to the end of the light tube assembly 1 in which wires do not leave the light tube assembly 1. The reason for this is that the wires entering the light tube assembly through the drilled cap 29 restrict the free motion of the CCFL lamp 23 at that point. Positioning the near spring 21b close to this point might pennit too much flexing of the CCFL lamp 23 about the near spring 21b.

The CCFL lamp 23 is mounted off center in soft white foam washers 21a and 21b, so that the reflector 24 approximates a parabolic reflector, even though it is cylindrical in shape. A colored and transparent slip of acetate or theatrical gel enhances the color of the CCFL lamp 23 and provides a decorative look to the light tube assembly. The reflector 24 is a slip of mirrored mylar or similarly reflective material, which hugs the inside of the polycarbonate tube 19. The reflector can also be achieved by applying a thin film of reflective material directly to the polycarbonate tube as with vacuum metalized plastic. The reflector 24 and the colored transparent lens 22 meet each other. Each takes up 180 degrees of the circle.

The number and placement of the springs can be optimized to the specific application. For example, a bicycle has pneumatic tires and large wheels with spokes, and thus inherently has significant damping, whereas a skateboard has small solid wheels, and is more susceptible to vibrations being passed through the mounting device and housing 19 to the lamp 23. A higher number of springs, spaced evenly along the lamp, will cushion the lamp better against harsh vibration. However, when a higher number of springs is used, it is more critical that the housing 19 itself not flex as this flex will more easily translate to the lamp 23. A thicker walled housing will resist flex more than a thinner walled housing. Thus, the invention is not intended to be limited by the number of springs, selected for a particular application.

Additionally it would be possible to find a colored polycarbonate tube, which would eliminate the need to insert a colored transparent lens.

The wires from the end of the light tube assembly pass through a strain relief 28 and then into a power inverter 26. The power inverter 26 accepts wires from one or two light tube assemblies. The power inverter 26 attaches to the bicycle/Tame by means of an adhesive backed strip of hook-and-loop fastener 26A. A coaxial quick-disconnect power connecter 25 allows the user to remove the battery pack from the lights without uninstalling the power inverter 26 or the light tube assemblies 1 and 2.

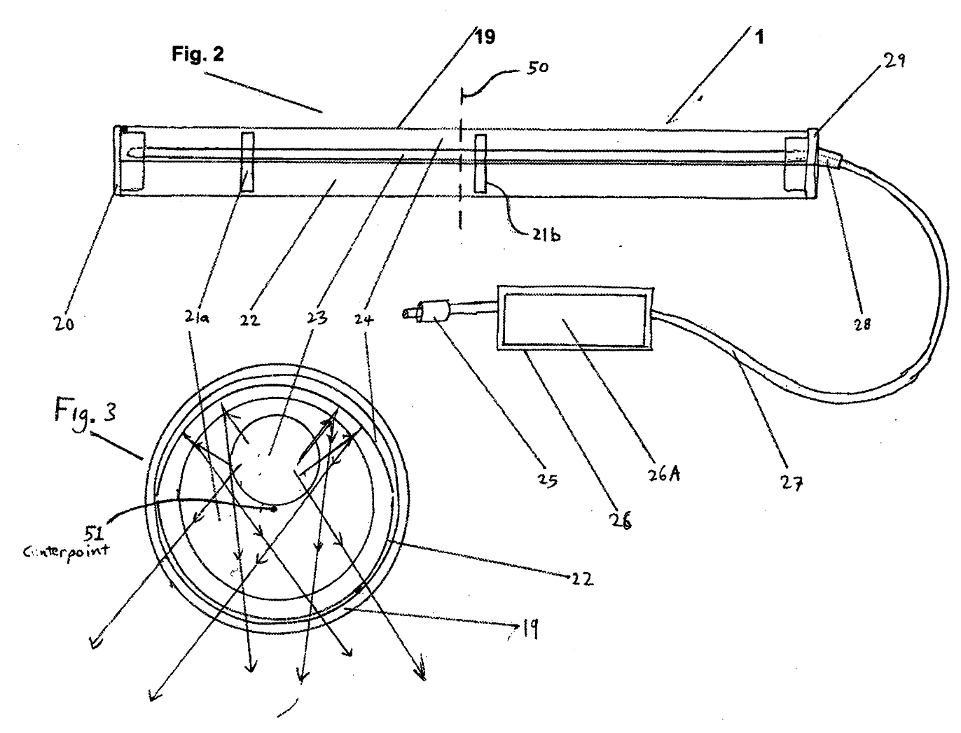

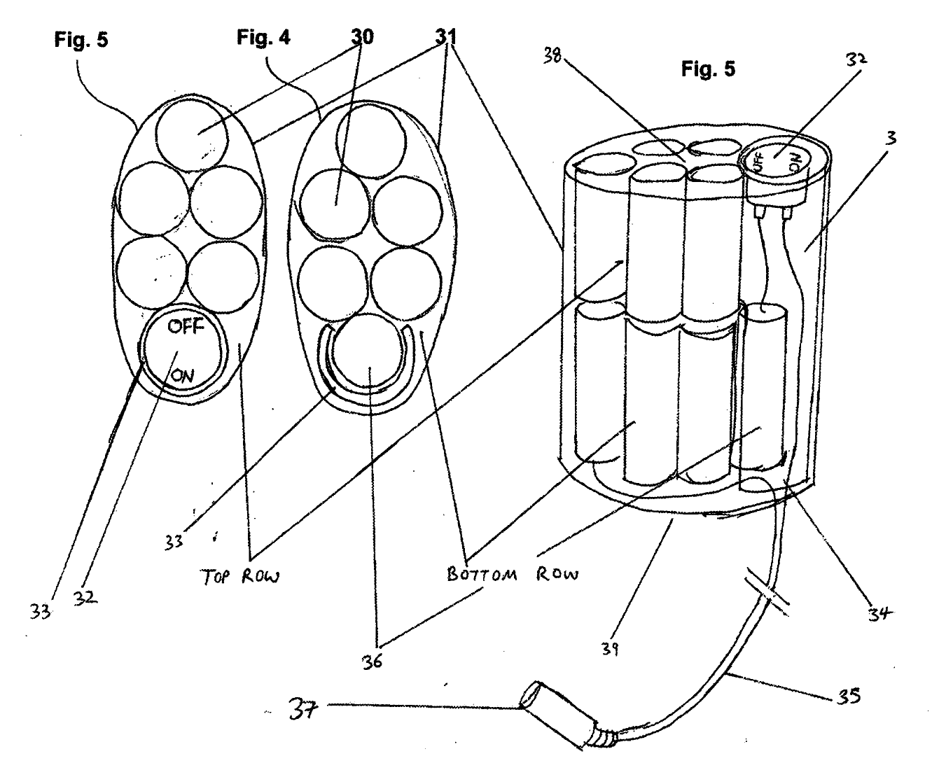

Referring now to FIG. 3, a close-up view of the battery pack.

The battery pack 10 is comprised of either 10 or 11 rechargeable Nickel Metal Hydride AA cells 30, electrostatically welded and glued into a pack, and then paired with an integrated switch 32 and enclosed in large-diameter heat shrink tubing 31. The top and bottom surfaces 38 and 39 of the battery pack 10 are protected with tape prior to the application of the large-diameter heat shrink tubing 31. A power wire 35 of approximately 12 inches runs off the pack, ending with a male quick disconnect power connector 37, which mates with the female power connector 25 of the inverter 8. The power switch is panel mount switch with a snap-in mounting style. It sits in a switch holding tube 33 that runs the length of the battery pack 10. The bottom end of the switch holding tube 33 is potted with glue 34 to seal the open end of the tube against water and to provide additional strain relief for power wires 35 leaving the battery pack 10. The optional 11th cell 36 fits inside a notch in the switch-holding tube 33.

The power wire running from the inverter 8 to the female quick-disconnect power connecter 25 is very short, approximately I to 1.5 inches. This is because the user may choose to disconnect the battery and remove it from the bicycle during the daytime, either for the purposes of charging the battery or to remove the heaviest component of the lighting system. With a short power wire leaving the power inverter 8, there is no need to secure this wire; it is rigid enough to stay in its position despite the vibrations from the road or trail. The battery comprises over 80% of the weight of the overall lighting system, so the ability to remove it quickly for daytime rides presents an advantage.

A potential version of this invention that runs on primary (store-bought) batteries is also possible. Due to the cost and inconvenience of replacing batteries, the preferred embodiment utilizes a sealed rechargeable pack. However, a version that runs on primary batteries would use a inverter 8 rated for 5 volts rather than 12. This would mean that the user would have to buy 4 AA or C sized batteries at a time, rather than 8 or 9.

Additionally, it would be possible to power the invention with a bicycle generator that clamps on the bicycle frame and rubs against the rear tire 17. However, such a generator would only power the lighting system when the bicycle was moving. Many users want the lighting system to work when the bicycle is stopped, for example, when they are waiting for a light to turn green at an intersection. It would be possible to store a few minutes worth of charge in a small battery that recharges when the cyclist is riding. However, the extra components would increase the cost of the lighting system and the complexity of installing it.

The power switch 32 saves users from having to disconnect the quick-disconnect power connector 9 each time they want to turn the lights ON or OFF. Including the power switch 32 in the battery pack removes the need for a handlebar-mounted switch. The power switch 32 on the battery pack is reachable by the bicycle rider while riding. If the power switch were not included with the lighting system or if the switch were integrated with the light tube assemblies 1 and 2 or with the inverter 8, the rider's reach to the switch might be too great to allow turning the lighting system ON and OFF while riding.

The power wires 6 and 7 from the light tube assemblies 1 and 2 are no longer than 12 inches in length. Unfortunately, lengthening the power wires 6 and 7 significantly can decrease the light output of light tube assemblies 1 and 2. If this were not the case, (or if technology changes to allow longer power wires from the inverter 8 without a drop in light output) a power switch integrated with the power inverter 8 could be useable by the cyclist while riding.

With respect to the above description of the preferred embodiment of the invention, it is to be realized that the optimum design of the battery pack 10 and light tube assemblies will vary as battery technology advances, and as the manufacturing capabilities increase. The current preferred embodiment is optimized for small production runs. However, with larger production comes the freedom to use injection molded parts, which might change the preferred embodiment of the springs 218 and 21b and of the battery pack 10.

With the foregoing description in mind, it is understood that the invention is not limited to the particular embodiments described herein, and that various rearrangements, modifications and substitutions may be implemented without departing from the true scope of the invention as hereinafter defined by the following claims and their equivalents.

I claim:

1. A lighting system for mounting to a vehicle for illuminating the ground beneath the vehicle, comprising:
at least one elongated, tubular lamp for mounting to the underside of the vehicle,
a mounting device for securing the elongated, tubular lamp to the vehicle in a manner that substantially minimizes flexing of the lamp, and
a reflective surface adjacent the lamp for creating a pattern of light to be directed at the ground.

2. The lighting system of claim 1, wherein the lamp is a Cold Cathode Florescent Light (CCFL) or similarly narrow and bright tubular lamp such as External Electrode Fluorescent Lamp (EEFL).

3. The lighting system of claim 2, wherein the pattern of light is viewable from a wide viewing angle.

4. The lighting system of claim 1, wherein the pattern of light demarcates a boundary between the vehicle and other vehicles.

5. The lighting system of claim 3, and further comprising a housing suitable for mounting to the vehicle for protecting the lamp from contact by extraneous objects, the housing being transparent.

6. The lighting system of claim 4, wherein the housing is tubular and includes end caps for enclosing the lamp in a manner rendering the lighting system water resistant.

7. The lighting system of claim 5, wherein the reflective surface extends around approximately half of the circumference of the tubular housing and wherein the tubular housing further includes a colored lens that extends around the remaining circumference of the housing.

8. The lighting system of claim 6, wherein the reflector and the lens meet along a flush juncture so as to create a seamless outward appearance.

9. The lighting system of claim 4, wherein the housing is flex-resistant in a manner that substantially evenly distributes vibration and impact forces to the lamp.

10. The lighting system of claim 8, wherein the housing is made of polycarbonate or similar impact resistant transparent structural material.

11. The lighting system of claim 1, and further comprising an isolation spring for isolating the lamp from movement of the vehicle in a manner that substantially minimizes flexing of the elongated lamp.

12. The isolation system of claim 10, wherein the isolation spring is mounted between the housing and the lamp and is positioned between ends of the lamp so that at least one end of the lamp can move relative to the housing.

13. The lighting system of claim 1, and further comprising a power source for connecting to the light tube assembly.

14. The lighting system of claim 12, wherein the power source includes battery, a power switch and an inverter.

15. The battery of claim 13, wherein the battery includes more than one battery cells, and the switch mounts alongside the battery cells so as to minimize space taken up by the switch.

16. The battery of claim 13, wherein the battery is easily disconnected from the light tube assembly.

17. A isolation system for mounting an elongated, tubular, substantially non-flexible lamp to a movable object for emitting light when connected to a power source, comprising:
a housing suitable for mounting to the object for protecting the lamp from contact by extraneous objects, the housing being transparent,
an isolation spring for isolating the lamp from movement of the object in a manner that substantially minimizes flexing of the elongated lamp,
the housing being flex-resistant in a manner that substantially evenly distributes forces to the lamp.

18. The isolation system of claim 16, wherein the isolation spring is mounted between the housing and the lamp and is positioned between ends of the lamp so that at least one end of the lamp can move relative to the housing.

19. The isolation system of claim 17, wherein one end of the lamp is connected to the power source, and wherein the isolation spring is offset from a centerpoint between the ends of the lamp, offset away from the end connected to the power source.

20. The isolation system of claim 16, wherein the lamp is a cold cathode florescent lamp (CCFL) or similarly narrow and bright elongated, tubular light source.

21. The isolation system of claim 16, wherein the housing fully encloses the lamp so as to make the isolation system water-resistant.

22. The isolation system of claim 20, wherein the housing includes a transparent tube and end caps.

23. The isolation system of claim 16, and further including a reflector adjacent to the housing for redirecting light emitted by the lamp.

24. The isolation system of claim 22, wherein the reflector is part of the housing, and wherein the housing includes a centerpoint and the lamp is held by the isolation springs offset from the centerpoint toward the reflector.

25. The isolation system of claim 23, wherein the lamp is offset in a manner to create a directed pattern of light.

26. The isolation system of claim 16, and further including caps for enclosing the housing to make it waterproof resistant

27. The isolation system of claim 16, and further comprising a mounting device suitable for mounting between the ends of the lamp for securing the housing to the movable object.

28. The isolation system of claim 16, wherein the power source includes an inverter and a battery.

29. The isolation system of claim 16, wherein the isolation spring is transparent.
